(19) United States
(12) Patent Application Publication
(10) Pub. No.: US 2015/0227408 A1
(43) Pub. Date: Aug. 13, 2015

(54) INFORMATION PROCESSING UNIT AND PROGRAM

(71) Applicant: Hitachi, Ltd., Tokyo (JP)

(72) Inventors: Hikaru Morita, Tokyo (JP); Takaki Kuroda, Tokyo (JP)

(21) Appl. No.: 14/428,097

(22) PCT Filed: Nov. 2, 2012
(86) PCT No.: PCT/JP2012/078534

§ 371 Date: Mar. 13, 2015

(51) Int. Cl. G06F 11/07; G06F 11/30

(52) U.S. Cl. CPC G06F 11/0769; G06F 11/0721; G06F 11/3051; G06F 11/3024

(57) ABSTRACT

A control unit of an information processing unit defines one or more monitoring target groups including a monitoring target device or a component of the monitoring target device as input by a monitoring user; and wherein when a first component is included in the monitoring target group, a failure occurs at a second component, and there is a specified relationship between the first component and the second component, and if a status of the first component is to be displayed via the monitoring target group, the control unit displays that the first component is in a critical state; and if the status of the first component is to be displayed without intermediary of the monitoring target group, the control unit displays that the first component is in a normal state and the first monitoring target device or the second component is in a critical state.

### TECHNICAL FIELD

The present invention relates to an information processing unit and program and is suited for use in an information processing unit and program for monitoring various devices and various jobs operated on the devices.

### BACKGROUND ART

Recently, with respect to operation and management of a computer system, there is a demand for not only management and monitoring on the basis of units of devices (computer equipment such as servers, storage equipment, network equipment, and databases), but also for management and monitoring on the basis of units of jobs operating on the devices.

So, upon the occurrence of a failure in a computer system for executing a plurality of jobs, Patent Literature 1 discloses a technique that not only specifies the location of the failure on a device basis, but also efficiently recognize the details of the failure and the range of influence caused by the failure. In the case of the occurrence of a failure, Patent Literature 1 can specify the failure and easily recognize the range of influence caused by the failure by displaying job configuration information, logical configuration information, and physical configuration information related to jobs to a job administrator who manages each job.

### CITATION LIST

### Patent Literature

[Patent Literature 1] U.S. Pat. No. 4,804,139

### SUMMARY OF INVENTION

### Problems to be Solved by the Invention

However, Patent Literature 1 displays only the configuration information about a target to which the job administrator can refer. Therefore, if a failure occurs at a device which the job administrator cannot refer, the problem is that the job administrator cannot recognize the failure of the device even if the failure has an influence on a job of the management target.

The present invention was devised in consideration of the above-described circumstances and aims at suggesting an information processing unit and program capable of specifying a device related to an management target of an administrator and elements constituting the device and providing status information about the management target in consideration of the status of the above-mentioned device and elements.

### Solution to Problem

In order to solve the above-described problem, provided according to the present invention is an information processing unit for monitoring a plurality of monitoring target devices, the information processing unit including: a memory unit for storing configuration information and status information about each of the monitoring target devices; a control unit for monitoring status information about the monitoring target device and a component including a function and part constituting the monitoring target device; and a display unit for displaying status information about the component; wherein the control unit defines one monitoring target group including the monitoring target device or the component of the monitoring target device as input by a monitoring user; and wherein when a first component is included in the monitoring target group and there is a specified relationship between the first component and the second component and if a failure occurs at a second component, and if a status of the first component is to be displayed via the monitoring target group, the control unit displays that the first component is in a critical state; and if the status of the first component is to be displayed without intermediary of the monitoring target group, the control unit displays that the first component is in a normal state and the first monitoring target device or the second component is in a critical state.

When the above-described configuration is employed and if the monitoring target device or the first component is added to the monitoring target group and a failure occurs at the second component, and if the status of the first component is to be displayed via the monitoring target group, the control unit displays that the first component is in a critical state; and if the status of the first component is to be displayed without intermediary of the monitoring target group, the control unit displays that the first component is in a normal state and the monitoring target device or the second component is in the critical state. As a result, it is possible to efficiently recognize influences on the management target at the time of the occurrence of a failure by specifying a device related to the management target of the administrator and elements constituting the device and providing status information about the management target in consideration of the status of the above-mentioned device and elements.

### Advantageous Effects of Invention

According to the present invention, it is possible to efficiently recognize influences on a management target at the time of the occurrence of a failure by specifying a device related to the management target of the administrator and elements constituting the device and providing status information about the management target in consideration of the status of the above-mentioned device and elements.

### BRIEF DESCRIPTION OF DRAWINGS

FIG. 1 is a conceptual diagram for explaining an embodiment of the present invention.

FIG. 2 is a block diagram showing a hardware configuration of a computer system according to the embodiment.

FIG. 3 is a block diagram showing the configuration of a management computer according to the embodiment.

FIG. 4 is a block diagram showing the configuration of a display computer according to the embodiment.

FIG. 5 is a block diagram showing the configuration of servers and a storage apparatus according to the embodiment.

FIG. 6 is a conceptual diagram for explaining definitions of management groups according to the embodiment.

FIG. 7 is a conceptual diagram for explaining presentation of the status of nodes and components according to the embodiment.

FIG. 8 is a chart showing the content of a node table according to the embodiment.

FIG. 9 is a chart showing the content of a component table according to the embodiment.

FIG. 10 is a chart showing the content of a component relation table according to the embodiment.

FIG. 11 is a chart showing the content of a group member table according to the embodiment.

FIG. 12 is a chart showing the content of a component status management table according to the embodiment.

FIG. 13 is a chart showing the content of a base component addition rule definition table according to the embodiment.

FIG. 14 is a flowchart illustrating component addition processing according to the embodiment.

FIG. 15 is a flowchart illustrating element addition processing according to the embodiment.

FIG. 16 is a flowchart illustrating element addition processing according to the embodiment.

FIG. 17 is a flowchart illustrating status update processing according to the embodiment.

FIG. 18 is a flowchart illustrating the status update processing according to the embodiment.

FIG. 19 is a flowchart illustrating the status update processing according to the embodiment.

FIG. 20 is a chart showing the content of a work table according to the embodiment.

FIG. 21 is a flowchart illustrating group display processing according to the embodiment.

FIG. 22 is a flowchart illustrating group member display processing according to the embodiment.

FIG. 23 is a flowchart illustrating base component expansion display processing according to the embodiment.

FIG. 24 is a conceptual diagram showing an example of a component display screen according to the embodiment.

FIG. 25 is a conceptual diagram showing an example of a component display screen according to the embodiment.

FIG. 26 is a conceptual diagram showing an example of a component display screen according to the embodiment.

FIG. 27 is a conceptual diagram showing an example of a component display screen according to the embodiment.

### DESCRIPTION OF EMBODIMENTS

An embodiment of the present invention will be explained below in detail with reference to drawings.

Incidentally, information about this invention will be explained in the description below, using expressions such as “aaa tables,” “aaa lists,” “aaa DBs,” and “aaa queues,” but these pieces of information may be expressed by means of other data structures such as tables, lists, DBs, and queues. Accordingly, information such as “aaa tables,” “aaa lists,” “aaa DBs,” and “aaa queues,” may be sometimes called “aaa information” in order to indicate that such information does not depend on the data structures. Moreover, expressions such as “identification information,” “identifier,” “name,” and “ID” are used when explaining the content of each piece of information, but they can be replaced with each other.

The following explanation may be given by using the word “program” as a subject. However, since a program is executed by execution of specified processing by a processor using a memory and a communication port (communication control device), the processor may be used as a subject in the explanation. Also, the processing disclosed by using a program as a subject may be processing executed by a computer such as a management computer or an information processing unit. Moreover, part or all programs may be implemented by dedicated hardware.

Furthermore, various programs may be installed in each computer by means of storage media which can be read by a program distribution server and the computer.

(1) Outlines of this Embodiment

The outlines of this embodiment will be firstly explained. Conventionally, the operation of nodes which constitute a network, such as servers, storage apparatuses, and network equipment, has been monitored on a node basis. Also, the operation of devices such as the servers and the storage apparatuses has been monitored on a device basis and the operation of jobs including the servers and elements constituting the servers such as logical volumes and ports (hereinafter referred to as the components) has been monitored on a job basis.

However, the conventional technology allows a job administrator to monitor only the status of nodes and components to which they can refer, so that the job administrator cannot recognize the status of components which are not related to a job group which is a management target. Therefore, if a failure occurs at a component that does not belong to the job group which is the management target, it is impossible to judge whether or not that failure will have an influence on the job group which is the management target.

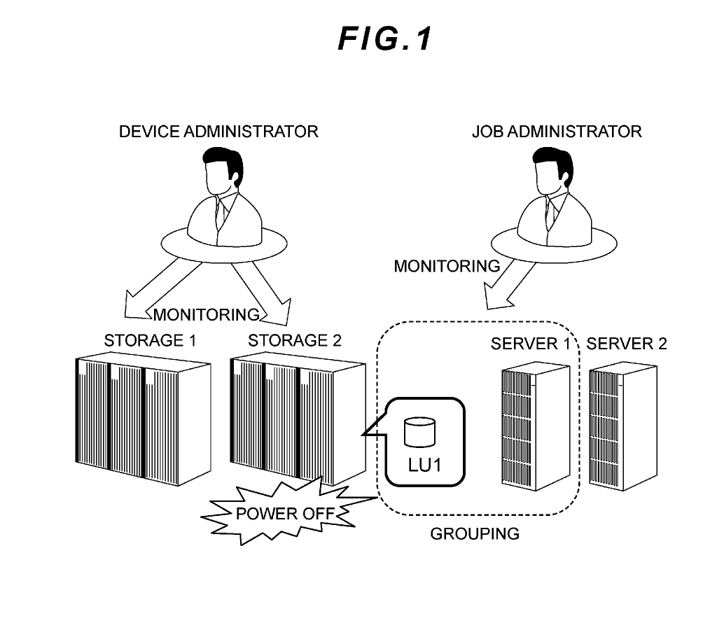

For example, according to the conventional technology as illustrated in FIG. 1, a device administrator manages a device group including Storage 1 and Storage 2 and the job administrator manages Server 1 and a logical volume LU1 of Storage 2, which are necessary components for a job to be managed, by grouping them. Under this circumstance, let us assume that power of Storage 2 goes off due to, for example, a failure. In this case, the device administrator monitors each of components constituting Storage 1 and Storage 2, so that a cause of the failure can be confirmed based on the status of the components of Storage 2 under control. On the other hand, the job administrator recognizes only the status of the components constituting the job group (Server 1 and the logical volume LU1), so that they cannot recognize that the failure of the power source which is outside the monitoring range has an influence on the job group which is the management target.

Accordingly, in this embodiment, when the job administrator adds a component(s) constituting a job group, a component(s) which serves as the basis for the relevant component(s) (hereinafter sometimes referred to as the base component(s)) is specified. Then, the status of the component constituting the job group is provided in consideration of the status of the base component.

For example, in the case of the above-described example, let us assume that the job administrator adds Server 1 and the logical volume LU1 as components constituting a job group. In this embodiment, base components such as a power source and a controller which will have an influence on the status of Server 1 and the logical volume LU1 are specified. Then, the status of the components is decided in consideration of the status of the specified base components, that is, the status of the power source and the controller.

As a result, devices related to the administrator's management target (components) and elements which will have an influence on the devices (base components) are specified, the status of the components can be decided in consideration of the status of the base components. Moreover, it is possible to efficiently recognize the influence on the management target at the time of the occurrence of a failure by displaying status information about the component(s) depending on the status of the administration such as the device administrator or the job administrator.

### (2) Configuration of Computer System

### (2-1) Hardware Configuration of Computer System

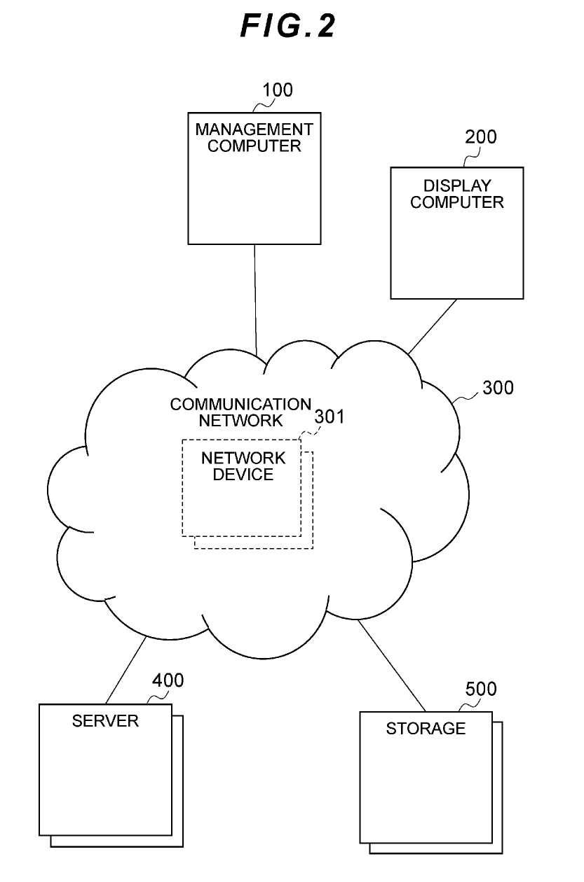

Next, the hardware configuration of the computer system will be explained. The computer system according to this embodiment includes a management computer 100, a display computer 200, a communication network 300, a server(s) 400, and a storage apparatus(es) 500 as illustrated in FIG. 2. The respective devices are connected via the communication network 300.

The management computer 100 is an information processing unit for the server(s) 400 and the storage apparatus(es) 500 which are connected via the communication network 300. The management computer 100 manages devices and components on the basis of each job management group or each device management group as input by the job administrator or the device administrator. Specifically speaking, the management computer 100 acquires the status of the devices and components and provides it to the display computer 200.

The job administrator is an administrator who manages devices, which are necessary for a certain job, and elements constituting the devices (components) by grouping them. Moreover, the device administrator is an administrator who collectively manages a plurality of devices included in a system.

Furthermore, components are elements constituting a device as described above and include not only those manufactured for exclusive use on the relevant device, but also general device elements. The components include, for example, a logical unit(s) (LU: Logical Unit(s)) which is an area obtained by logically dividing a disk drive, and a port(s) for inputting and outputting data. The job administrator adds information about, for example, an LU or port which is necessary for a job, to a job group.

The display computer 200 includes, for example, a display device and provides the job administrator and the device administrator with the status of a management target device and components, which is acquired by the management computer 100. FIG. 2 illustrates the management computer 100 and the display computer 200 as separate devices; however, the invention is not limited to this example and the management computer 100 and the display computer 200 may be configured as one device.

The communication network 300 is configured by including a plurality of network devices 301 and is configured by including, for example, wire cables such as copper wires or optical fibers, data transmission channels such as wireless radio waves, or data relay devices such as base stations for controlling routers and communications.

The server 400 is an information processing unit for controlling inputting or outputting of data into or from the storage apparatus 500 and writes and reads data by using a specified area provided by the storage apparatus 500.

The storage apparatus 500 is an information processing unit for providing storage areas to the server 400 and is composed of, for example, semiconductor memories such as SSDs (Solid State Drives), expensive high-performance disk drives such as SAS (Serial Attached SCSI) disks or FC (Fibre Channel) disks, or inexpensive low-performance disk drives such as SATA (Serial AT Attachment) disks.

### (2-2) Configuration of Management Computer

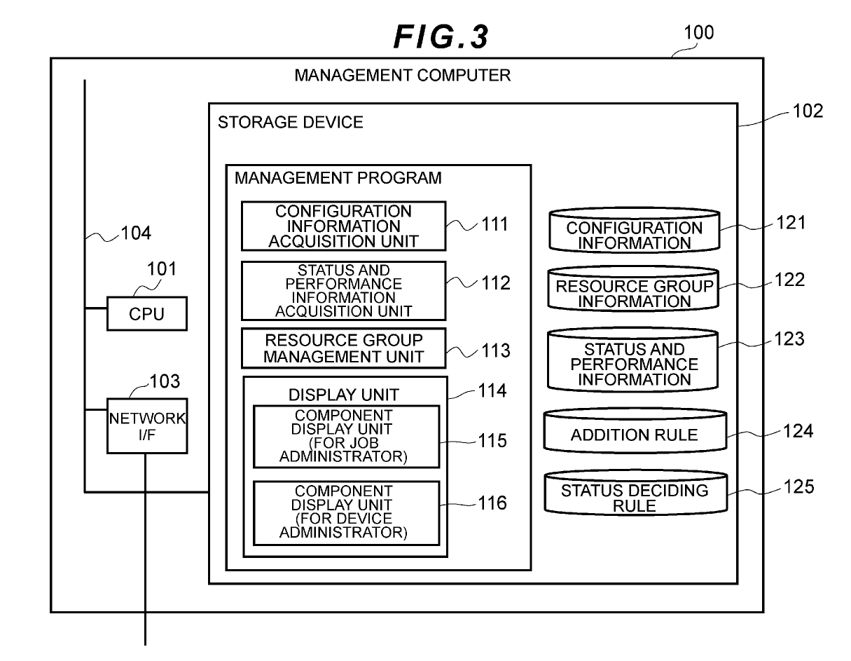

Next, the configuration of the management computer 100 will be explained with reference to FIG. 3. The management computer 100 includes a CPU 101, a storage device 102, a network interface (which is indicated as Network I/F in the drawing) 103 and a bus 104 as illustrated in FIG. 3.

The CPU 101 serves as an arithmetic processing unit and control device and controls the entire operation in the management computer 100 in accordance with various programs stored in the storage device 102. Moreover, the CPU 101 may be a microprocessor.

The storage device 102 may be composed of, for example, a ROM (Read Only Memory) or a RAM (Random Access Memory) and stores a management program 110, which has various functions, and various management tables. The functions of the management program 110 include, for example, a configuration information acquisition unit 111, a status and performance information acquisition unit 112, a resource group management unit 113, and a display unit 114. Moreover, the management tables include configuration information 121, resource group information 122, status and performance information 123, an addition rule 124, and a status deciding rule 125.

The configuration information acquisition unit 111 has a function acquiring configuration information about the system including, for example, the server(s) 400 and the storage apparatus(es) 500 managed by the management computer 100. The status and performance information acquisition unit 112 has a function acquiring status information and performance information, which are acquired from the configuration information acquisition unit 111, about the server(s) 400 and the storage apparatus(es) 500 constituting the system. The resource group management unit 113 has a function managing, for example, the status of each resource group which is set by the administrator, such as a device management group or a job management group.

The display unit 114 has a function providing various information to the administrator and includes, for example, a component display unit 115 for the job administrator and a component display unit 116 for the device administrator. The component display units 115 and 116 have a function that has a display screen display, for example, configuration information and status information about devices and components included in a job management group or a device management group.

Moreover, the configuration information 121 stores configuration information, which is acquired from the configuration information acquisition unit 111, about the system. The configuration information 121 includes, for example, configuration information about nodes, configuration information about components, and information indicating the relationship between the components. The resource group information 122 stores information about resource groups registered by the job administrator or the device administrator. The resource group information 122 includes information for managing members included in the resource groups. The status and performance information 123 stores information such as the status and performance of components included in each resource group.

The addition rule 124 stores information indicating rules for adding, for example, base components of components registered in resource groups by the administrator. The status deciding rule 125 stores information indicating rules used to decide the status of a component in consideration of the status of base components.

Moreover, the network interface 103 is an interface for connecting to the communication network 300 and has a function acquiring the configuration information and the status information about the server(s) 400 and the storage apparatus(es) 500. Furthermore, the bus 104 has a function mutually connecting the devices, such as the CPU 101 and the storage device 102, in the management computer 100.

### (2-3) Configuration of Display Computer

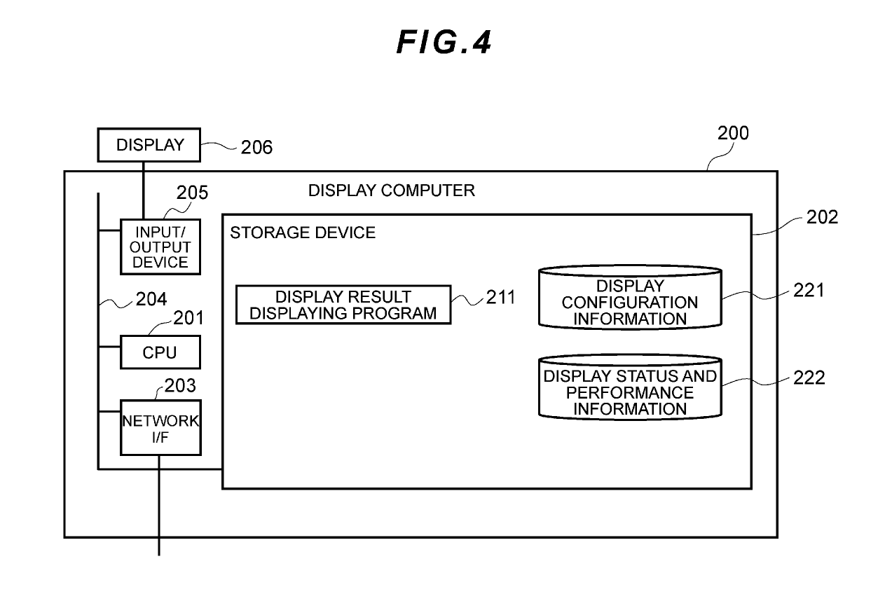

Next, the configuration of the display computer 200 will be explained with reference to FIG. 4. The display computer 200 includes a CPU 201, a storage device 202, a network interface (which is indicated as Network I/F in the drawing) 203, a bus 204, an input/output device 205, and a display 206 as illustrated in FIG. 4.

The CPU 201 serves as an arithmetic processing unit and control device and controls the entire operation in the display computer 200 in accordance with various programs stored in the storage device 202. Moreover, the CPU 201 may be a microprocessor.

The storage device 202 may be composed of, for example, a ROM (Read Only Memory) or a RAM (Random Access Memory) and stores various programs such as a display result displaying program 211 and includes various management tables such as display configuration information 221 and display status information 222.

The display result displaying program 211 has a function that has the display 206 display the configuration information and the status information, which are acquired by the management computer 100, about components on the basis of units of groups registered by the administrator.

Moreover, the display configuration information 221 is information created by processing the component configuration information, which is acquired by the management computer 100, for the purpose of display. Furthermore, the display status information 222 is information created by processing the component status information, which is acquired by the management computer 100, for the purpose of display.

Furthermore, the network interface 203 is an interface for connecting to the communication network 300 and has a function that acquires the configuration information and the status information about the server(s) 400 and the storage apparatus(es) 500 from the management computer 100. Furthermore, the bus 104 has a function mutually connecting the devices, such as the CPU 201 and the storage device 202, in the display computer 200. Moreover, the display 206 is a display device for displaying the display configuration information 221 and the display status and performance information 222 by means of texts or images.

### (2-4) Configuration of Server and Storage Apparatus

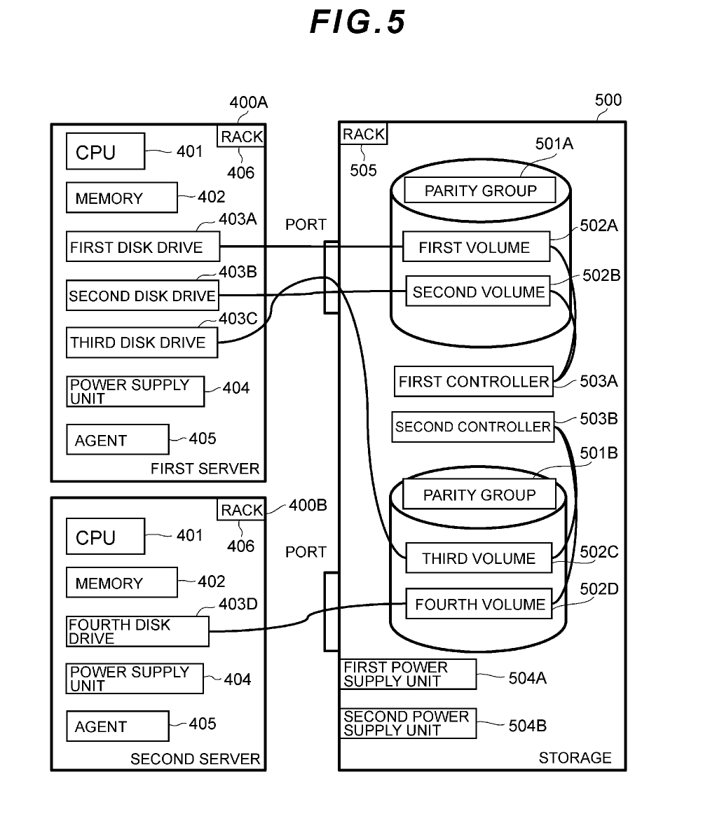

Next, the configuration of the server 400 and the storage apparatus 500 will be explained with reference to FIG. 5. The computer system may include a plurality of servers 400 and a plurality of storage apparatuses 500 as illustrated in FIG. 2. Referring to FIG. 5, a case in which storage areas provided to one storage apparatus 500 are used by two servers 400A and 400B will be explained.

The server 400A includes a CPU 401, a memory 402, a first disk drive 403A, a second disk drive 403B, a third disk drive 403C, a power supply unit 404, and an agent 401 as illustrated in FIG. 5.

The CPU 401 serves as an arithmetic processing unit and control device and controls the entire operation in the first server 400A in accordance with various programs stored in the storage device 402. Moreover, the CPU 401 may be a microprocessor. The memory 402 is composed of, for example, a ROM (Read Only Memory) or a RAM (Random Access Memory).

The first disk drive 403A, the second disk drive 403B, and the third disk drive 403C are drives for reading and writing data stored in the storage apparatus 500 and each disk drive is allocated to a logical volume(s) of the storage apparatus 500.

The power supply unit 404 is a device for supplying power to the first server 400A. Moreover, the agent 401 monitors the status information about the server 400A and provides it to the management computer 100.

Since the second server 400B has the same configuration as that of the first server 400A, any detailed explanation about it has been omitted.

Moreover, the storage apparatus 500 includes, for example, parity groups 501A and 501B, a first controller 503A, a second controller 503B, a first power supply unit 504A, and a second power supply unit 504B.

The parity groups 501A and 501 B are groups of hard disk drives to implement RAID configurations. A RAID group is defined with a plurality of storage devices and one or more volumes are defined in storage areas provided by one or more storage devices constituting one RAID group. Referring to FIG. 5, a first volume 502A and a second volume 502B are defined in the parity group 501A and a third volume 502C and a fourth volume 502D are defined in the parity group 501B.

The first controller 503A and the second controller 503B have a function that manages volumes in hard disks; and the first controller 503A manages the first volume 502A and the second volume 502B and the second controller 503B manages the third volume 502C and the fourth volume 502D.

The first power supply unit 504A and the second power supply unit 504B are devices for supplying power to the storage apparatus 500.

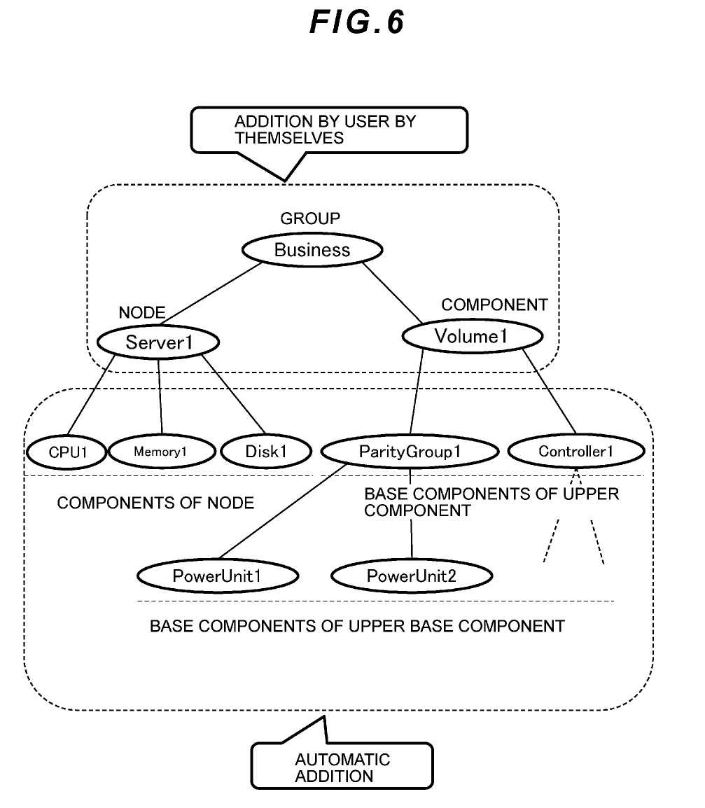

Furthermore, as illustrated in FIG. 6, nodes such as servers and components such as volumes, which are necessary to execute a specified job, are registered as one job group as input by the job administrator. Nodes indicate devices such as servers and storage apparatuses. Components indicate functions and parts in the nodes. The job administrator can manage the nodes and the components by allocating them to resource groups (RG). For example, if a node called Server 1 (the first server 400A) and Volume 1 (the first volume 502A) are necessary to execute a job called “Business,” the user (the job administrator) allocates Sever 1 and Volume 1 to a job management group called “Business.”

In this embodiment, CPU 1 (the CPU 401), Memory 1 (the memory 402), and Disk 1 (the first disk drive 403A) are automatically added as components which constitute Server 1. Moreover, Parity Group 1 (the parity group 501A) and Controller 1 (the first controller 503A), which are upper components of Volume 1, are automatically added as components which constitute Volume 1. Furthermore, Power Unit 1 (the first power supply unit 504A) and Power Unit 2 (the second power supply unit 504B), which are base components of Parity Group 1, are automatically added. FIG. 6 shows a tree structure to which the nodes and the components are added. The status of upper components depends on the status of lower components in the tree structure.

Accordingly, in this embodiment, for example, upper components and base components which will have an influence on a node or component added to a job group by the job administrator are automatically added in accordance with a specified rule. Furthermore, the status information about the added component is acquired and the status of the nodes and components necessary for a job is presented to the job administrator in consideration of the status of the base components which will have an influence on them.

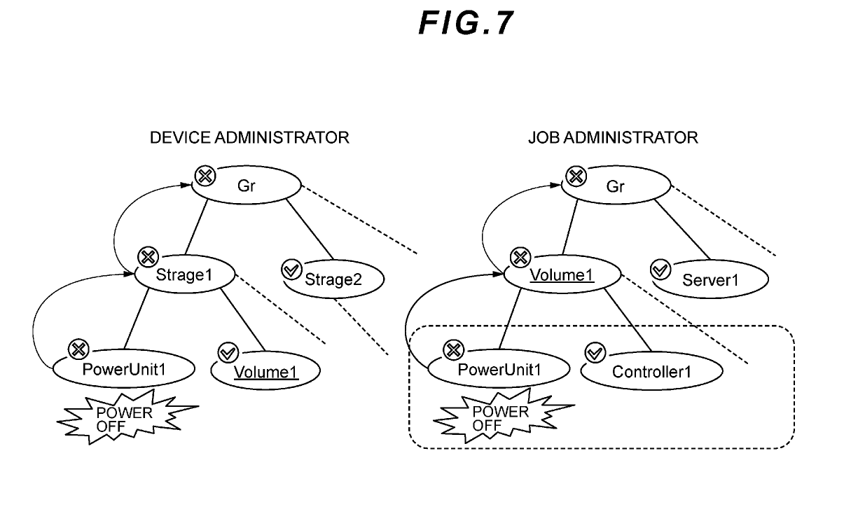

For example, if Volume 1 and Server 1 are added to group Gr by the job administrator as illustrated in FIG. 7, Power Unit 1 and Controller 1 are automatically added as base components of Volume 1. Let us assume that if the power of Power Unit 1 goes off under this circumstance, the status of Volume 1 is not a normal state (Critical) due to the influence by Power Unit 1 even if the status of Volume 1 is normal. As a result, if the power of Power Unit 1 goes off, it is no longer necessary for the job administrator themselves to judge whether the power-off will have an influence on the job or not.

On the other hand, regarding devices registered in the device management group Gr of the device administrator, it is only necessary to know whether or not the status is normal on a device basis. So, if the power of Power Unit 1 goes off, it is determined that the status of Power Unit 1 is not normal and the status of Volume 1 is normal.

Accordingly, in this embodiment, the status of the components can be changed and displayed depending on the status of the administrator, so that it is possible to effectively provide information which is required by the device administrator or the job administrator to manage the devices and the components.

### (3) Structures of Various Tables

Next, various management tables stored in the storage device 102 of the management computer 100 will be explained.

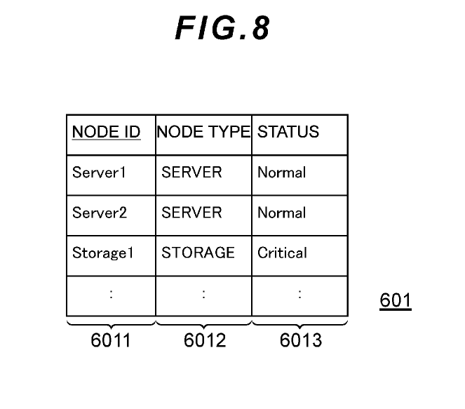

Firstly, the configuration information about nodes will be explained. A node table 601 is a table for managing the configuration of the nodes; and is constituted from a node ID column 6011, a node type column 6012, and a status column 6013 as illustrated in FIG. 8.

The node ID column 6011 stores identification information for identifying a node. The node means a device constituting a computer device which is a management target as described earlier. The node type column 6012 stores information indicating the type of the relevant node. The node type can be, for example, a server or a storage apparatus. The status column 6013 stores information indicating the status of the relevant node. When the node is in a normal state, “Normal” indicating the normal state is stored; and when the node is not in a normal state, “Critical” indicating the critical state is stored.

FIG. 8 shows that, for example, the type of a node which is Server 1 is a server (SERVER) and the status of Server 1 is normal (Normal).

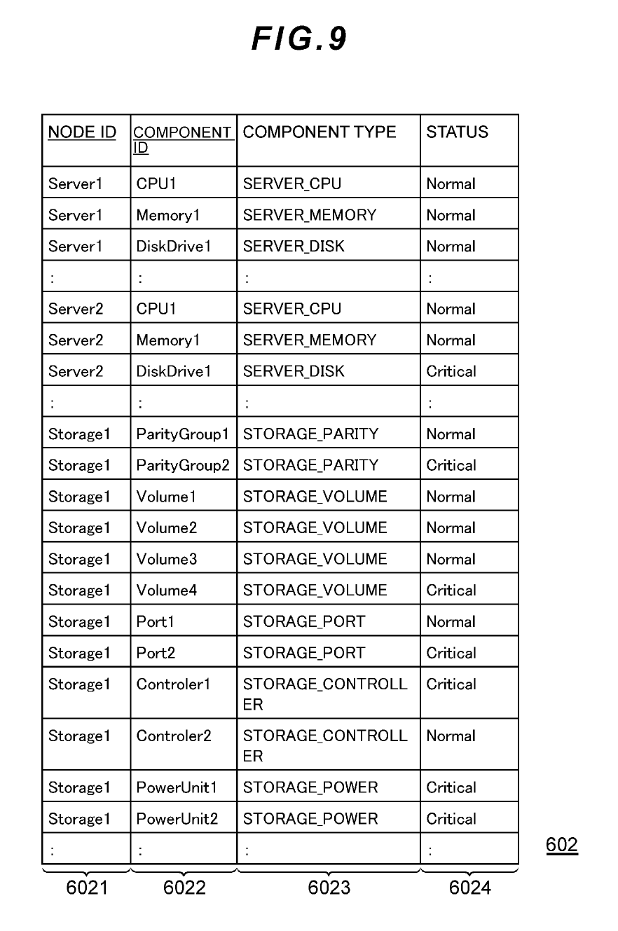

Next, the configuration information about components will be explained. A component table 602 is a table for managing the configuration of the components; and is constituted from a node ID column 6021, a component ID column 6022, a component type column 6023, and a status column 6024 as illustrated in FIG. 9.

The node ID column 6021 stores information for identifying the relevant node. The component ID column 6022 stores information for identifying the relevant component. The component means a function or part of the node as described earlier. The component type column 6023 stores information indicating the type of the component. The component type can be, for example, a CPU, a memory, a disk drive, or a logical volume. The status column 6024 stores information indicating the status of the component. When the component is in a normal state, “Normal” indicating the normal state is stored; and when the component is not in a normal state, “Critical” indicating the critical state is stored.

FIG. 9 shows that, for example, the type of a component “CPU 1” which is a component constituting the node “Server 1” is a server CPU (Server_CPU) and its status is normal (Normal).

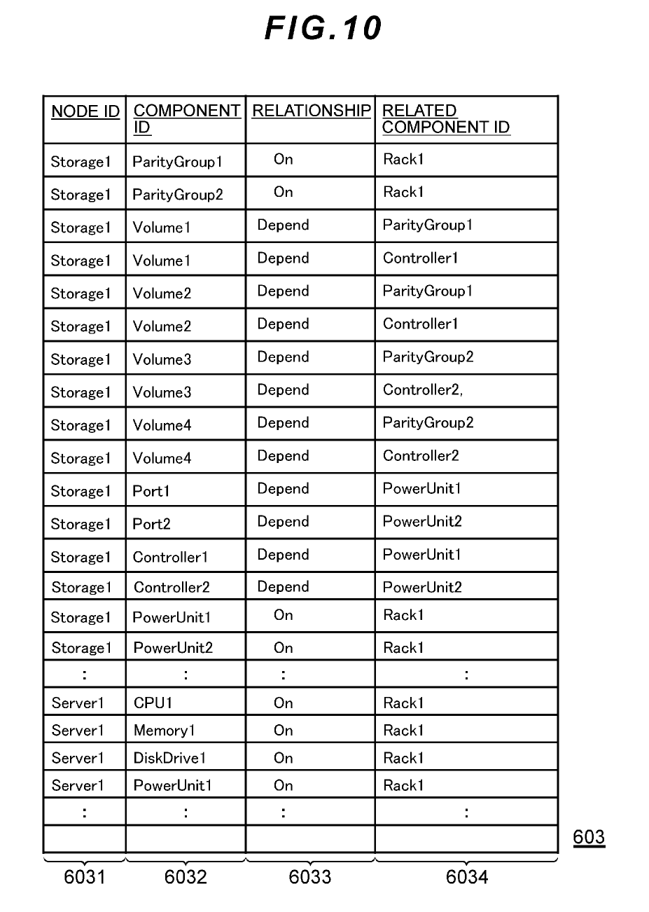

Next, the dependence relationship of components will be explained. A component relation table 603 is a table for managing the dependence relationship of each component; and is constituted from a node ID column 6031, a component ID column 6032, a relationship column 6033, and a related component ID column 6034 as illustrated in FIG. 10.

The node ID column 6031 stores information for identifying the relevant node. The component ID column 6032 stores information for identifying the relevant component. The relationship column 6033 stores information indicating the relationship with a related component described later. The related component ID column 6034 stores information for identifying a component on which the component stored in the component ID column 6032 depends, or in which that component is included. For example, if the component in the component ID column 6032 depends on the component in the related component ID column 6034, the relationship column 6033 stores “Depend”; and if the component in the component ID column 6032 is included in related component ID column 6034, the relationship column 6033 stores “On.”

FIG. 10 shows that, for example, Parity Group 1 which is a component constituting the node “Storage 1” depends on Rack 1 and the relationship between Parity Group 1 and Rack 1 is “On” which means Parity Group 1 is included in Rack 1.

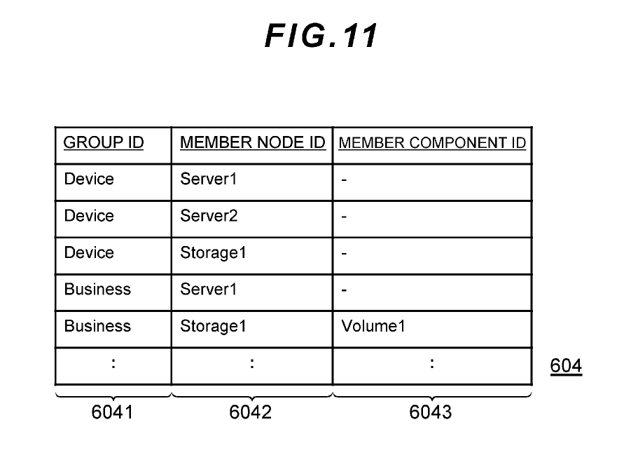

Next, group member definition information will be explained. A group member table 604 is a table for managing member information about each group; and is constituted from a group ID column 6041, a member node ID column 6042, and a member component ID column 6043 as illustrated in FIG. 11.

The group ID column 6041 stores information for identifying a device group or a job group. The member node ID column 6042 stores identification information about nodes belonging to each group. The member component ID column 6043 stores identification information about components constituting each node.

FIG. 11 shows that, for example, nodes belonging to a “Device” group (device management group) are Server 1, Server 2, and Storage 1. FIG. 11 also shows that nodes belonging to a “Business” group (job management group) are Server 1 and Storage 1 and a component constituting Storage 1 is Volume 1.

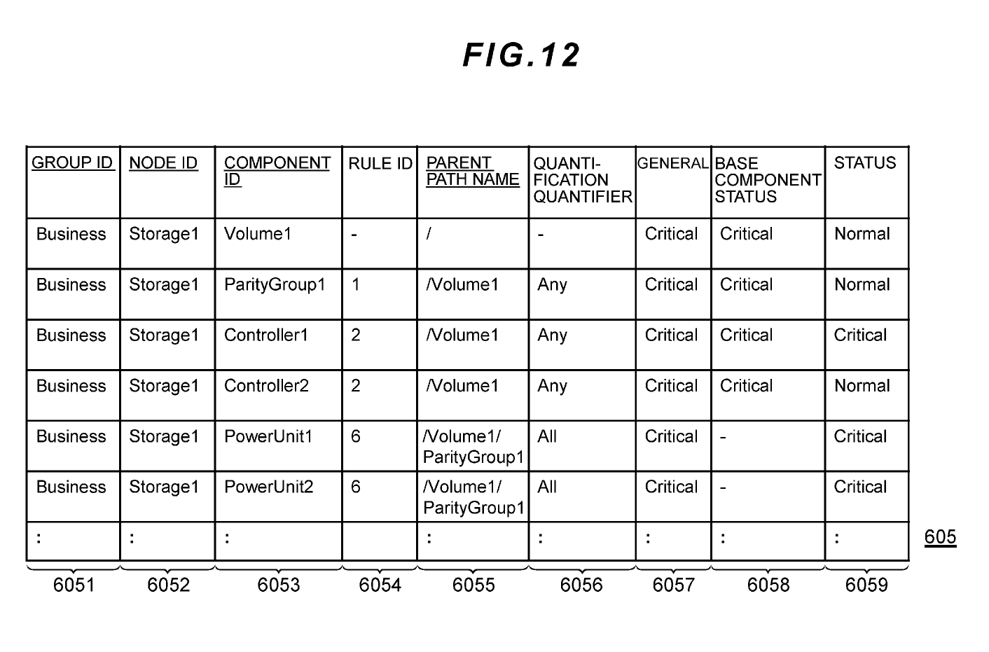

Next, the status management information about components will be explained. A component status management table 605 is a table for managing the status of components; and is constituted from a group ID column 6051, a node ID column 6052, a component ID column 6053, a rule ID column 6054, a parent path name column 6055, a quantification quantifier column 6056, a general column 6057, a base component status 6058, and a status column 6059 as illustrated in FIG. 12.

The group ID column 6051 stores information for identifying a device management group or a job management group. The node ID column 6052 stores information for identifying nodes belonging to each group. The component ID column 6053 stores information for identifying components constituting each node. The rule ID column 6054 stores information for identifying a rule for adding a preset base component(s). The rule for adding the base component(s) will be explained later.

The parent path name column 6055 stores information indicating a path name of an upper component of each component in a tree structure of the relevant management group. When there are a plurality of base components on which the component depends, the quantification quantifier column 6056 stores information indicating a standard for deciding a general status of the base components. For example, if there is at least one component, which is not normal, among the plurality of base components, the quantification quantifier column 6056 stores “Any” indicating that the general status of the base components is not normal (critical). Moreover, if all the plurality of base components are not normal, the quantification quantifier column 6056 stores “All” indicating that the general status of the base components is not normal (critical). Moreover, if n pieces of components are not normal among the plurality of base components, the quantification quantifier column 6056 stores “+n” indicating that the general status of the base components is not general (critical).

Furthermore, the general column 6057 stores information indicating the general status of the base components as decided by the aforementioned quantification quantifier. The status column 6059 stores information indicating the status of each component.

FIG. 12 shows that, for example, regarding the component Parity Group 1 of the node Storage 1 belonging to a Business group (job management group), a base component is added in accordance with the base component addition rule “Rule 1,” its parent path name is “/Volume 1,” its quantification quantifier is “Any,” the general status of the base component is “Critical,” the status of the base component is “Critical,” and the status of the component is “Normal.”

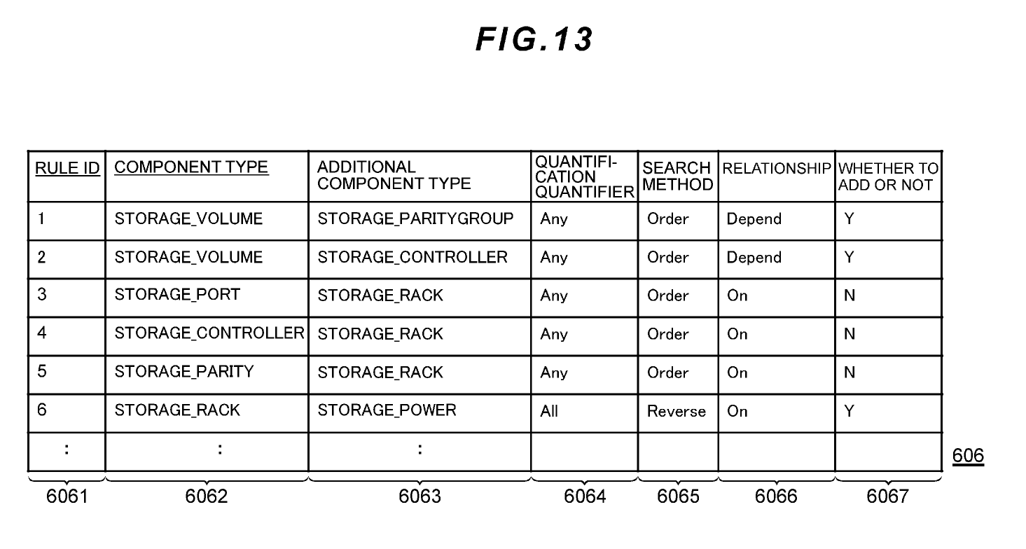

Next, base component addition rule definition information will be explained. A base component addition rule definition table 606 is constituted from a rule ID column 6061, a component type column 6062, a additional component type column 6063, a quantification quantifier column 6064, a search method column 6065, a relationship column 6066, and a whether-to-add-or-not column 6067 as illustrated in FIG. 13.

The rule ID column 6061 stores information for identifying a base component addition rule. The component type column 6062 stores information indicating the type of the relevant component. The additional component type column 6063 stores information indicating the type of an additional component as a base component of the relevant component according to the type of the component. The quantification quantifier column 6064 stores information indicating the aforementioned quantification quantifier.

The search method column 6065 stores information indicating a search method, that is, “Order” or “Reverse.” The relationship column 6066 stores information indicating the relationship between the component and the additional component. If the component depends on the additional component, the relationship column 6066 stores “Depend”; and if the component is included in the additional component, the relationship column 6066 stores “On.” The whether-to-add-or-not column 6067 stores information indicating whether or not to add the additional component to the target component. For example, if the additional component is to be added, the whether-to-add-or-not column 6067 stores “Y”; and if the additional component is not to be added, the whether-to-add-or-not column 6067 stores “N.”

FIG. 13 shows that, for example, the base component addition rule 1 indicates a rule for a component type “STORAGE_VOLUME” and its additional component type is “STORAGE_PARITYGROUP.” Then, the quantification quantifier of “STORAGE_PARITYGROUP” to be added is “Any,” its search method is “Order,” the component “STORAGE_VOLUME” has the relationship of dependence on the additional component “STORAGE_PARITYGROUP” (Depend), and the base component is to be added to the component (Y).

### (4) Details of Various Processing

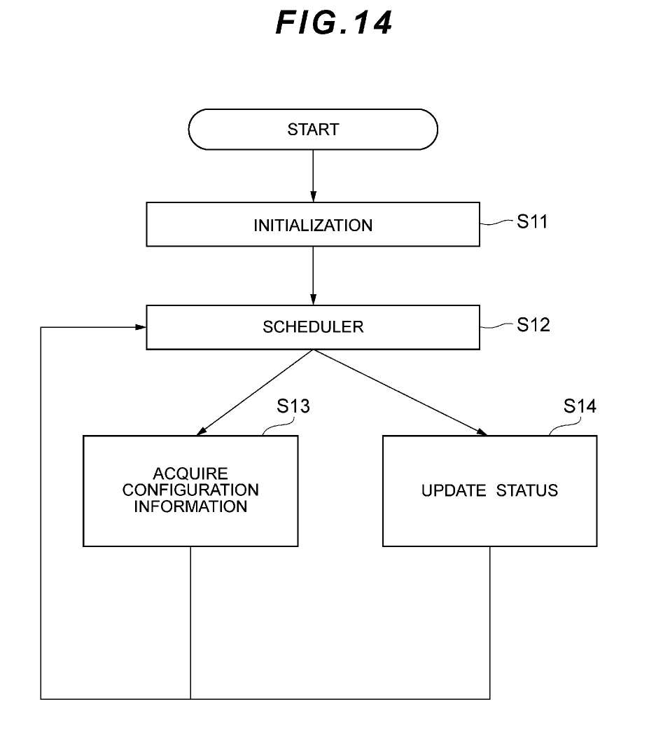

Next, component addition processing by the management computer 100 will be explained. Firstly, the entire processing will be explained with reference to FIG. 14. The management program 110 of the management computer 100 executes specified initialization processing (S11) and then periodically executes, according to a scheduler (S12), configuration information acquisition processing (S13) and status update processing (S14) as illustrated in FIG. 14.

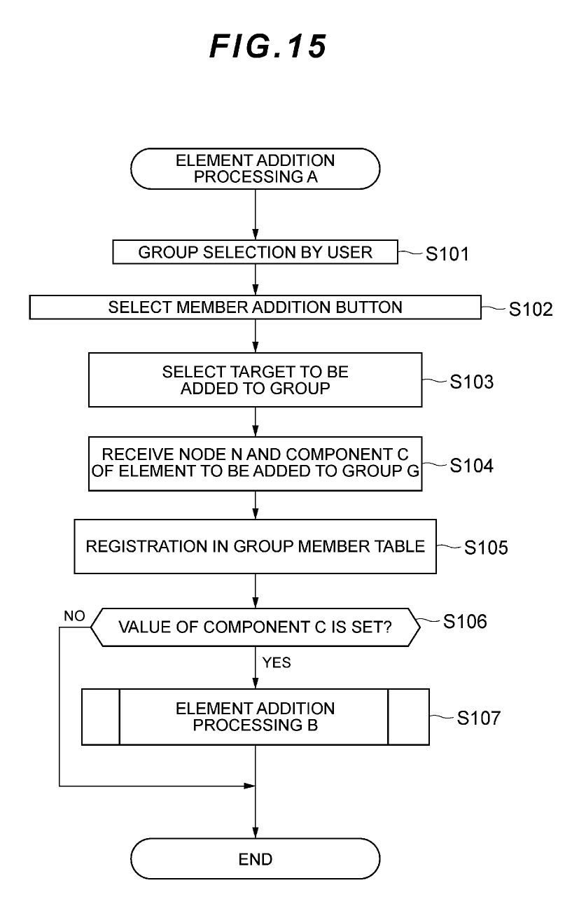

Firstly, the details of the configuration information acquisition processing in step S13 will be explained. The configuration information acquisition processing for adding a node or a component to a device management group or a job management group is executed by the configuration information acquisition unit 111. The configuration information acquisition unit 111 firstly executes element addition processing A for adding an element to a group as illustrated in FIG. 15.

The configuration information acquisition unit 111 selects a group as input by the user (S101). Then, a member addition button is selected as input by the user (S102) and node N and component C of the node, which are targets to be added to the group selected in step S101, are selected (S103).

Then, the configuration information acquisition unit 111 receives node N and component C which are elements to be added to group G selected in step S103 (S104). Subsequently, the configuration information acquisition unit 111 registers the group ID of group G, the node ID of node N, and the component ID of component C in the group member table 604 (S105).

Then, the configuration information acquisition unit 111 judges whether the value of component C registered in step S105 is set or not (S106). If it is determined in step S105 that the value of component C is set, the configuration information acquisition unit 111 executes element addition processing B for adding the element to a group (S107). On the other hand, if it is determined in step S105 that the value of component C is not set, the relevant element is not the component and the configuration information acquisition unit 111 terminates the element addition processing A.

The element addition processing B in step S107 is processing for adding a base component to the added component when the component is added to the relevant group by the element addition processing A. The base component is added to each group based on the base component addition rule definition table 606.

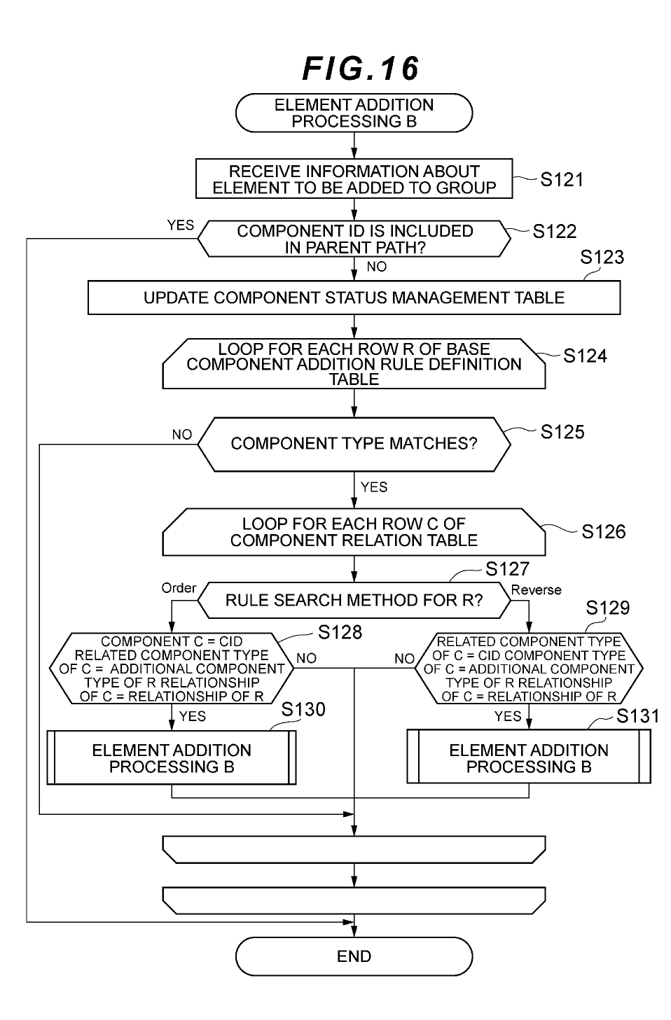

The configuration information acquisition unit 111 receives information about the element to be added to the group (S121) as illustrated in FIG. 16. The information about the element to be added to the group in step S121 is information such as the group ID, the node ID, the component ID, the parent path, or the quantification quantifier.

Subsequently, the configuration information acquisition unit 111 judges whether the parent path received in step S121 includes its own component ID or not (S122). Furthermore, in step S122, the configuration information acquisition unit 111 judges whether or not the component status management table 605 includes those matching the received group ID, node ID, and component ID.

If it is determined in step S122 that the parent path includes its own component ID, the configuration information acquisition unit 111 terminates the element addition processing B. On the other hand, if it is determined in step S122 that the parent path does not include its own component ID, the configuration information acquisition unit 111 updates the component information management table (S123). Specifically speaking, the configuration information acquisition unit 111 stores the information received in step S121 about the elements to be added to the group (the group (GID), the node (NID), the component (CID), the parent path or the quantification quantifier) in the component status management table 605.

Subsequently, the configuration information acquisition unit 111 loops the processing from step S124 to step S133 with respect to each row R of the base component addition rule definition table 606.

The configuration information acquisition unit 111 judges whether the component type of component CID stored in the component status management table 605 in step S123 matches the component type of row R (S125). The component type of the component CID can be acquired by referring to the component table 602. For example, the component table 602 shows that the component type of the node “Storage 1” and the component “Volume 1” is “STORAGE_VOLUME.” Then, the configuration information acquisition unit 111 judges whether or not there is any component type, which matches this component type (STORAGE_VOLUME), in the base component addition rule definition table 606.

If it is determined in step S125 that there is a matching component type, the configuration information acquisition unit 111 loops the processing from step S126 to step S132. On the other hand, if it is determined in step S125 that there is no matching component type, the configuration information acquisition unit 111 terminates the loop processing from step S126 to step S132.

The configuration information acquisition unit 111 loops the processing from step S127 to step S132 with respect to each row C of the component relation table 603.

Firstly, the configuration information acquisition unit 111 judges whether the search method which is the rule for the target row R of the base component addition rule definition table 606 is “Order” or “Reverse” (S127). If the search method is “Order” in step S127, the configuration information acquisition unit 111 executes processing in step S128 and subsequent steps from the left to the right of the tree structure of the group. On the other hand, if the search method is “Reverse” in step S127, the configuration information acquisition unit 111 executes processing in step S129 and subsequent steps from the right to the left of the tree structure of the group.

In step S128, the configuration information acquisition unit 111 judges whether or not the component type and relationship of the component relation table which matches the target component ID are the same as the component type and relationship of the base component addition rule definition table 606 (S128). If they match each other in step S128, the configuration information acquisition unit 111 executes the element addition processing B (S130). In step S130, the configuration information acquisition unit 111 recursively calls the element addition processing B by specifying the group ID, the node ID, the related component ID, the parent path, and the quantification quantifier as information about the element to be added to the group.

In step S129, the configuration information acquisition unit 111 judges whether or not the component type and relationship of the component relation table which matches the target component ID are the same as the component type and relationship of the base component addition rule definition table 606 (S129). If they match each other in step S129, the configuration information acquisition unit 111 executes the element addition processing B (S131). In step S131, the configuration information acquisition unit 111 recursively calls the element addition processing B by specifying the group ID, the node ID, the related component ID, the parent path, and the quantification quantifier as information about the element to be added to the group.

For example, assuming that Volume 1 is added to a “Business” group by the user, “Business, Storage 1, Volume 1, /, -” is received in step S121. Then, since the parent path is “/,” “NO” is selected as the judgment for step S122. Then, (Business, Storage 1, Volume 1, /, -) is stored in the component status management table 605 in step S123.

Furthermore, reference is made to the rule ID=1 of the base component addition rule definition table 606 in step S125. Since the component type “STORAGE_VOLUME” of the rule ID=1 matches the component type “STORAGE_VOLUME” in the component status management table 605, “YES” is selected for the judgment of step S125. Then, since the search method for the rule ID=1 is “Order,” the judgment of step S128 is performed. In step S128, whether the component ID of the component relation table 603 matches the component ID of the base component addition rule definition table 606 or not, whether the related component type matches the additional component type or not, and whether the relationships match each other or not are judged. Since the component ID is Volume 1, the component type is “STORAGE_{—} VOLUME,” and the relationship is “Depend,” and they match each other, “Business, Storage 1, Parity Group 1, /Volume 1, Any” is delivered to the group element addition processing B in step S130.

Then, as “Business, Storage 1, Parity Group 1, /Volume 1, Any” is received in step S121, “Parity Group” is not included in the parent path “/Volume 1” in step S122, and the component status management table 605 does not include any matching GID, NID, or CID, “NO” is selected for the judgment. Then, in step S123, “Business, Storage 1, Parity Group 1, /Volume 1, Any” is stored in the component status management table 605.

The element addition processing B is repeated by referring to the base component addition rule definition table 606 and the component relation table 603 as described above until no more base component to be added to the management group is found, thereby updating the component status management table 605.

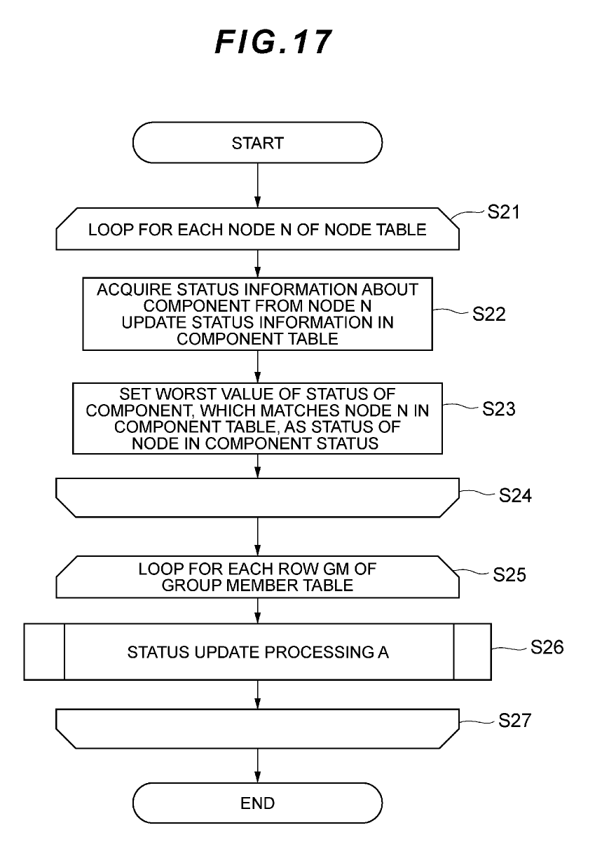

Next, the details of the status update processing in step S14 of FIG. 14 will be explained. The status and performance of each device and component are acquired by the status and performance information acquisition unit 112. The status and performance information acquisition unit 112 loops the processing from step S21 to S27 with respect to each node N in the node table 601 as illustrated in FIG. 17. The loop processing illustrated in FIG. 17 is executed periodically at specified intervals.

Firstly, the status and performance information acquisition unit 112 acquires the status information about components constituting node N from node N and updates the status information about the components regarding node N in the component table 602 (S22).

Then, the status and performance information acquisition unit 112 sets the worst value of the status of the same node N in the component table 602 to the node table 601 as the status information about node N.

Next, the status and performance information acquisition unit 112 loops the status update processing A in step S26 on each row GM of the group member table 604 (S26). If the loop processing in step S26 is completed (S27), the status and performance information acquisition unit 112 terminates the status and performance information processing.

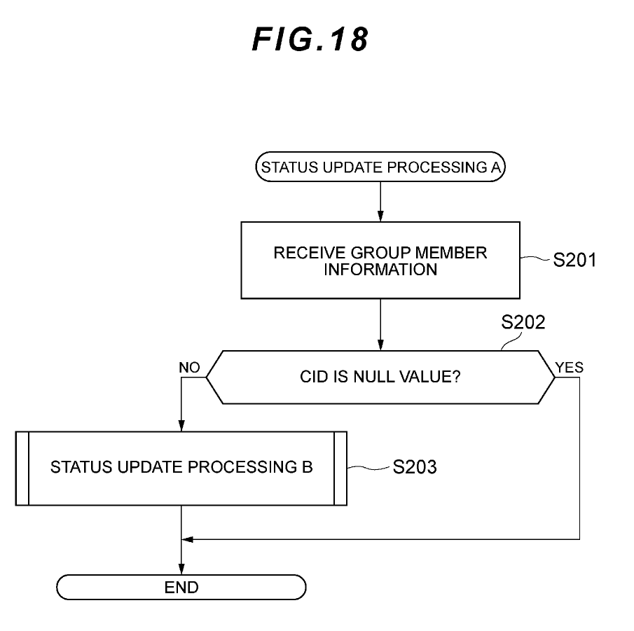

The status update processing A in step S26 will be explained. The status and performance information acquisition unit 112 receives information about a member added to a group as illustrated in FIG. 18 (S201). In step S201, the status and performance information acquisition unit 112 receives the group ID (GID) of the group, the node ID (NID) added to the group, and the component ID (CID) (S201).

Then, the status and performance information acquisition unit 112 judges whether the component ID (CID), among the member information received in step S201, is a null value or not (S202). If the component ID is a null value in step S202, it means that the element added to the group is a node. In other words, whether the element to be added to the group is a node or a component is judged in step S202.

If it is determined in step S202 that the component ID (CID) is a null value, the status and performance information acquisition unit 112 terminates the status update processing A. On the other hand, if it is determined in step S202 that the component ID (CID) is not a null value, the status and performance information acquisition unit 112 executes the status update processing B (S203). In other words, if the element to be added to the group is a component, the status and performance information acquisition unit 112 executes the processing for recognizing the status of base component of that component (the status update processing B).

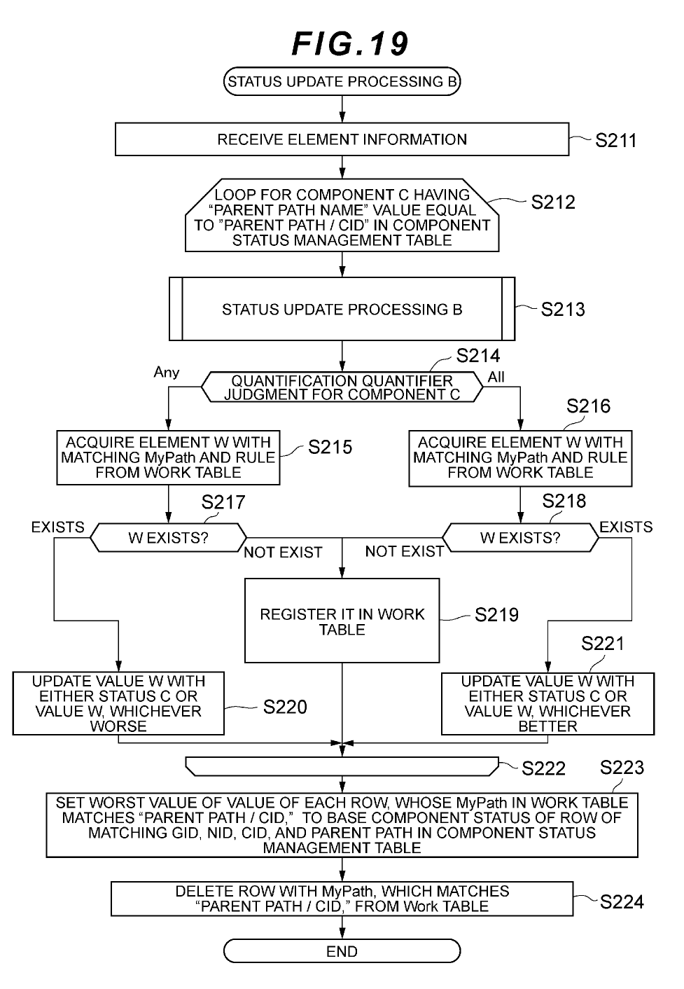

The status and performance information acquisition unit 112 receives information about the element to be added to the group as illustrated in FIG. 19 (S211). Specifically speaking, the status and performance information acquisition unit 112 receives information of the group ID (GID), the node ID (NID), the component ID (CID), and the parent path.

Then, the status and performance information acquisition unit 112 loops the processing from step S213 to step S222 with respect to component C whose parent path name in the component status management table 605 is a value equivalent to “parent path/CID” received in step S211.

In step S213, the status and performance information acquisition unit 112 recursively calls the status update processing B with respect to component C of the component information management table corresponding to the parent path name “parent path/CID” after the loop processing.

Firstly, the status and performance information acquisition unit 112 refers to the component status management table 605 and judges the quantification quantifier of component C (S214). If the quantification quantifier of component C is “Any” in step S214, the status and performance information acquisition unit 112 executes processing in step S215 and subsequent steps. On the other hand, if the quantification quantifier of component C is “All” in step S214, the status and performance information acquisition unit 112 executes step S216 and subsequent steps.

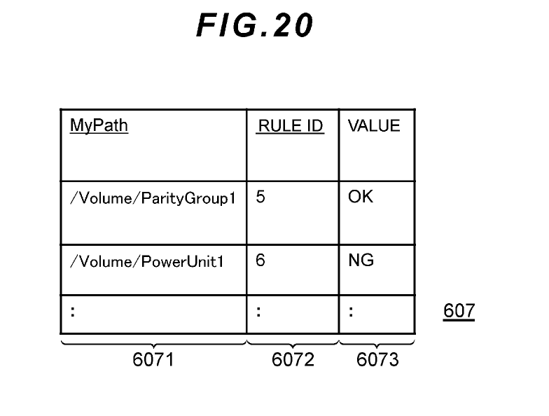

In step S215, the status and performance information acquisition unit 112 acquires element W with matching My Path and rule from a work table 607 illustrated in FIG. 20. Then, the status and performance information acquisition unit 112 judges whether element W with matching My Path and rule exists in the work table 607 or not (S217).

The work table 607 is a work table temporarily stored in the storage device of the management computer 100. The work table 607 is constituted from a My Path column 6071, a rule ID column 6072, and a value column 6073 as illustrated in FIG. 20. Each column temporarily stores information at the time of the update processing during the status configuration processing B. The My Path column 6071 stores a parent path of a component on which the update processing is being executed. The rule ID column 6072 stores identification information about a base component addition rule for the component on which the update processing is being executed. The value column 6073 stores information indicating the status of the component on which the update processing is being executed.

If it is determined in step S217 that element W exists in the work table 607, the status and performance information acquisition unit 112 compares the status of the target component with the value of the work table and updates the value of the value column 6073 in the work table 607 with the worse value.

On the other hand, if it is determined in step S217 that element W does not exist in the work table 607, the status and performance information acquisition unit 112 registers element W in the work table 607 (S219). Specifically speaking, the status and performance information acquisition unit 112 stores the value of the parent path name column 605 of the target component of the component status management table 605 in the My Path column 6071 of the work table 607. The status and performance information acquisition unit 112 also stores the value of the rule ID column 6054 of the component status management table 605 in the rule ID column 6072 of the work table 607. Moreover, the status and performance information acquisition unit 112 stores the value of the status column 6059 of the component status management table 605 in the value column 6073 of the work table 607.

Furthermore, in step S216, the status and performance information acquisition unit 112 acquires element W with matching My Path and rule from the work table 607 illustrated in FIG. 20. Then, the status and performance information acquisition unit 112 judges whether element W with matching My Path and rule exists in the work table 607 or not (S218).

If it is determined in step S218 that element W exists in the work table 607, the status and performance information acquisition unit 112 compares the status of the target component with the value of the work table and updates the value of the value column 6073 in the work table 607 with the worse value.

On the other hand, if it is determined in step S218 that element W does not exist in the work table 607, the status and performance information acquisition unit 112 registers element W in the work table 607 (S219).

After the loop processing from step S212 to step S222 is completed, the status and performance information acquisition unit 112 sets the worst value of values in each row, whose value of the My Path column 6071 of the work table 607 matches the “parent path/component ID,” as a value of the base component status (S223). Specifically speaking, the status and performance information acquisition unit 112 stores the worst value of values in each row, whose value of the My Path column 6071 of the work table 607 matches the “parent path/component ID,” in the base component status column 6058 of a row which matches the group ID, the node ID, and the component ID in the component status management table 605.

Then, the status and performance information acquisition unit 112 deletes the row whose My Path matches the “parent path/CID” from the work table 607 (S224).

For example, if information about the element of the management group “Business, Storage 1, Volume 1, /” is received in step S211, the processing from step S212 to step S222 is looped with respect to “Parity Group 1” having the same “parent path name” value as the parent path / component ID “/Volume 1” in the component status management table 605. Furthermore, the processing from step S212 to step S222 is looped with respect to “Power Unit 1” having the same “parent path name” value as “/Volume 1/Parity Group 1.” As a result of the above-described loop processing, it is possible to store the status of all the base components of the component, the status of the component itself, and the general status of the component in consideration of the status of all the base components in the component status management table 605.

Next, display processing by the management computer 100 will be explained. The display processing for displaying the status information about nodes and components of a device management group or a job management group on the display computer 200 is executed by the display unit 114.

Group display processing will be firstly explained. The display unit 114 receives group selection information (group ID: GID) as input by the user (S301).

Then, the display unit 114 executes loop processing from step S302 to step S306 on an element group member (GM) in the group member table 604, which matches the group ID received in step S301.

The display unit 114 firstly judges whether the member component ID column 6043 of the group member table 604 is a null value or not (S303). If the member component ID column 6043 is a null value, it means that the member element is a node.

If it is determined in step S303 that the member component ID column 6043 is a null value, the display unit 114 acquires row N of the node table 601, which matches the value of the member node ID column 6042 in the group member table 604, and displays the value of the status column 6013 of row N in a status column and a general (Status) column of a display screen (S304).

On the other hand, if it is determined in step S303 that the member component ID column 6043 is not a null value, the display unit 114 acquires row C of the component status management table 605, which matches the group ID, the group member node ID, the group member component ID, and “/,” and displays the acquired information on the display screen (S305).

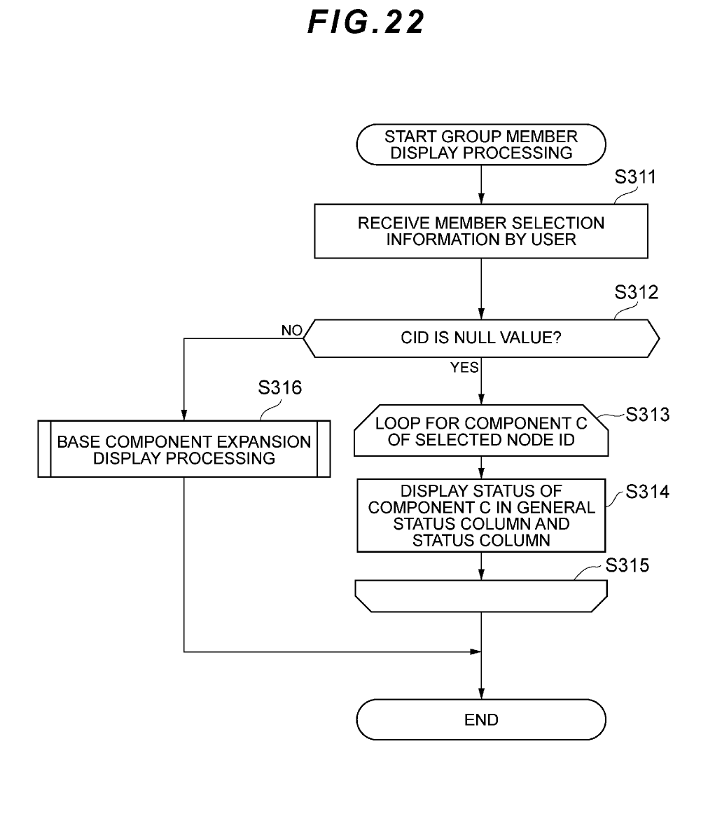

Next, group member display processing will be explained. The display unit 114 receives member selection information as input by the user as illustrated in FIG. 22 (S311). Specifically speaking, the display unit 114 receives the group ID (GID), the node ID (NID), and the content ID (CID).

Then, the display unit 114 judges whether the content ID (CID), among the information received in step S311, is a null value or not (S312). If the content ID is a null value, it means that the element is a node.

If it is determined in step S312 that the content ID (CID) is a null value, the display unit 114 executes loop processing from step S313 to step S315 with respect to component C with the node ID selected by the user.

The display unit 114 displays the status information of component C of the component table 602 of the selected component in the general status column and the status column on the display screen (S314).

On the other hand, if it is determined in step S312 that the component ID (CID) is not a null value, the display unit 114 executes base component expansion display processing on the target component (S316).

The details of the base component expansion display processing in step S316 described above will be explained. The display unit 114 receives the component selection information (the group ID, the node ID, the component ID, and the parent path) selected as input by the user (S321).

Then, the display unit 114 loops the processing in step S323 with respect to row F whose group ID and node ID in the component status management table 605 match each other and whose parent path is identical to the “parent path/CID.”

In step S323, the display unit 114 displays the status information, which is stored in the general column 6057, the base component status column 6058, and the status column 6059 of row F of the component status management table 605, as the general status, the status of the base component, and the status respectively on the display screen.

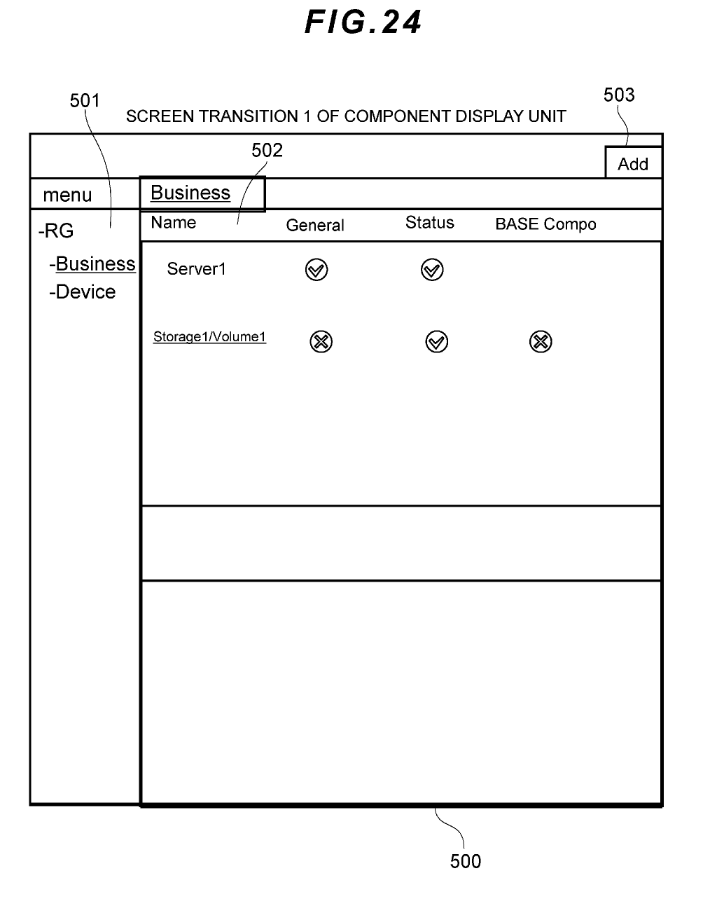

Next, the content of the display screen by the above-described display processing by the display unit 114 will be explained. FIG. 24 is an example of a component display screen 500 for displaying components. The component display screen 500 includes a menu column 501 and a status display column 502. The menu column 501 displays a list of resource groups (RG) such as device management groups and job management groups registered as input by the user. Moreover, the status display column 502 displays names of nodes and components and the status of the nodes or the components by associating them with each other. The status of the node and the content includes, for example, the general status of the relevant node and component, the status of the relevant node and component themselves, and the status of base components.

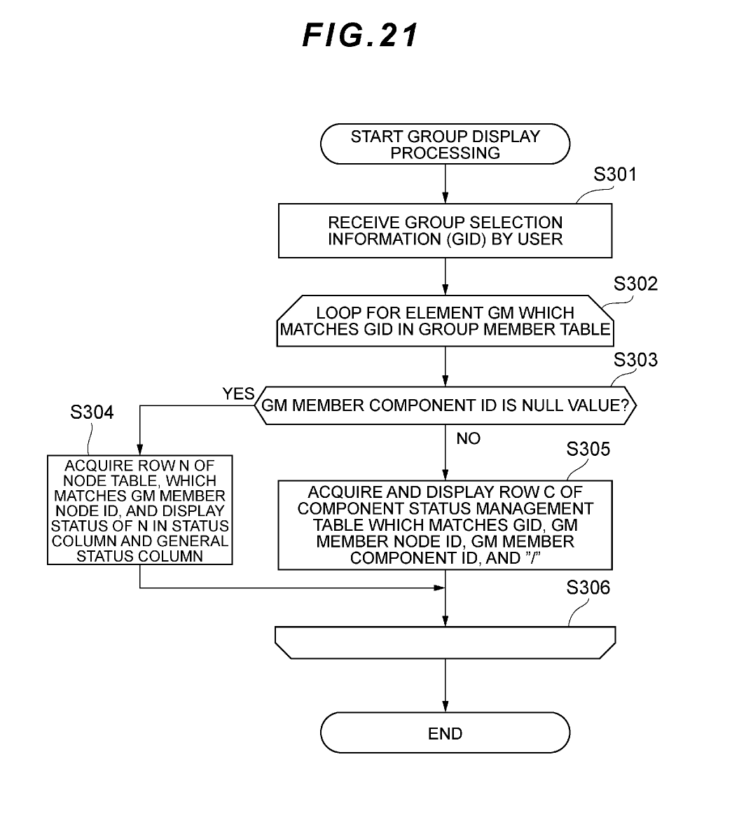

For example, if “Business” which is a job management group is selected by the user from among the resource groups (RG) on the component display screen 500 illustrated in FIG. 24, the node “Server 1” and the components “Storage 1/Volume 1” which are added to the job management group “Business” are displayed by the aforementioned group display processing in FIG. 21 and their respective status information is displayed.

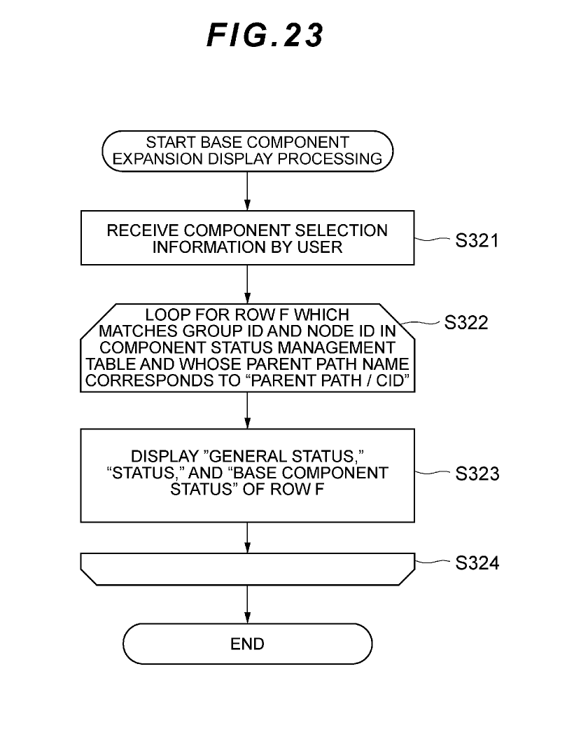

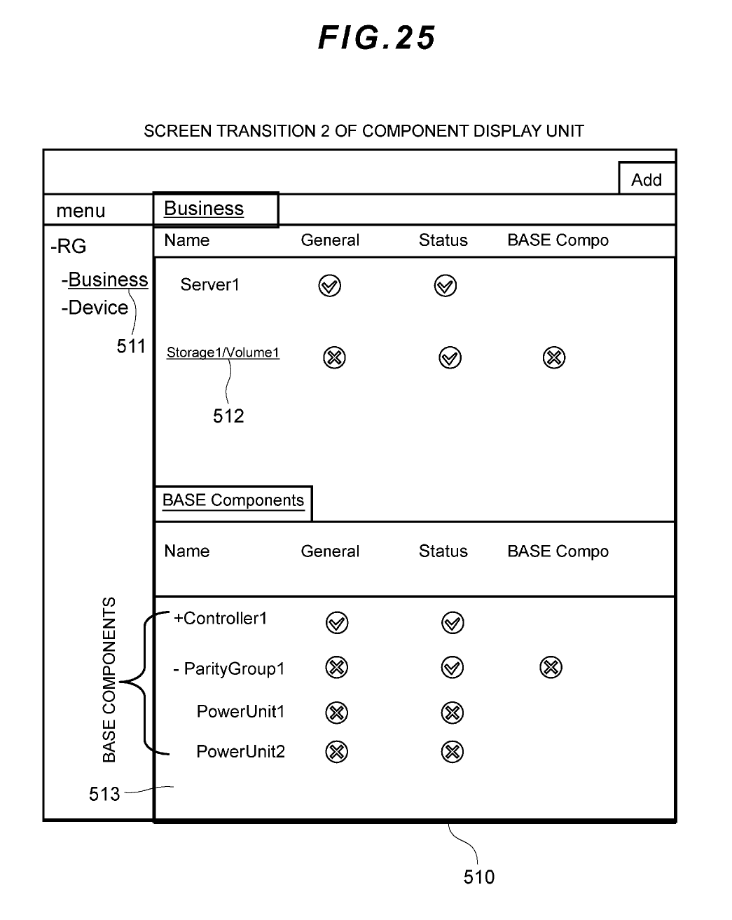

Furthermore, if “Storage 1/Volume 1” is selected on the component display screen 500 in FIG. 24, a component display screen 510 illustrated in FIG. 25 is expanded and displayed. Referring to FIG. 25, the status information of each component and the status information about base components are displayed by the group member display processing illustrated in FIG. 22 and the base component expansion display processing illustrated in FIG. 23.

FIG. 25 shows that base components of “Storage 1/Volume 1” are Controller 1, Parity Group, Power Unit 1, and Power Unit 2. It is shown that while the general status of “Storage 1/Volume 1” is not normal, Volume 1 of Storage 1 itself has not failed, but Power Unit 1 and Power Unit 2 of the base components have failed. Incidentally, the display of the status information about the base components is expanded and displayed on the same screen as the screen where the nodes and the components are displayed as illustrated in FIG. 25; however, the invention is not limited to this example and the status information about the base components may be displayed on another screen. Furthermore, referring to FIG. 25, the components and the base components are displayed respectively in the upper and lower parts of one screen, but they may be displayed on the right and left sides of one screen.

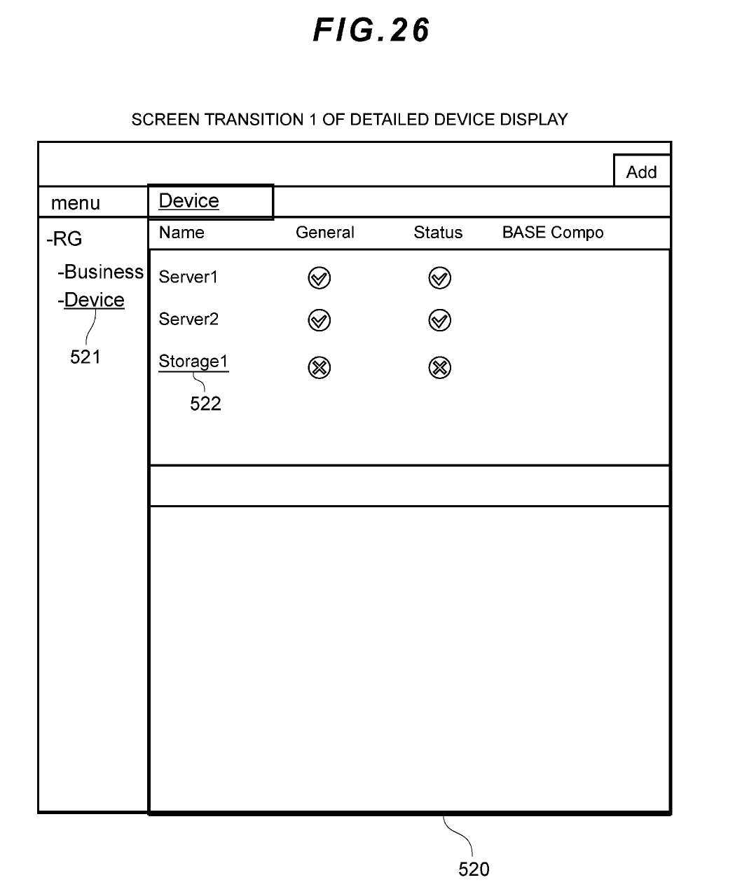

Furthermore, if “Device” which is a device management group is selected by the user from among the resource groups (RG) as illustrated in FIG. 26, the nodes “Server 1,” “Server 2,” and “Storage 1” which are added to the device management group “Device” are displayed by the aforementioned group display processing in FIG. 21 and their respective status information is displayed.

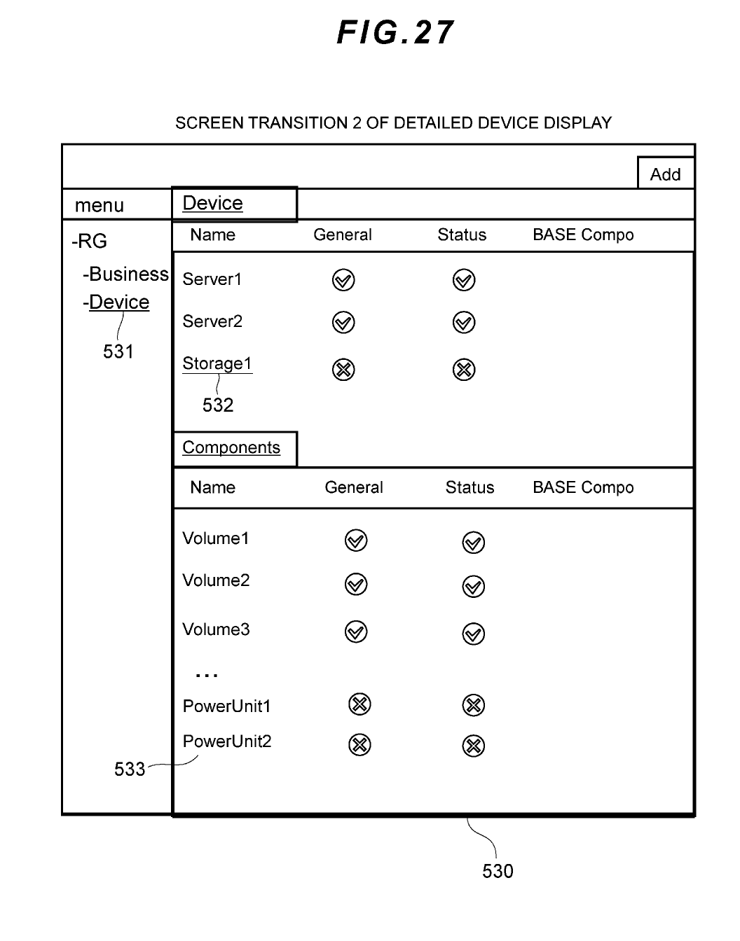

Furthermore, if “Storage 1” is selected on the component display screen 520 in FIG. 25, a component display screen 530 illustrated in FIG. 27 is expanded and displayed. Referring to FIG. 27, the status information about each component is displayed by the group member display processing illustrated in FIG. 22.

FIG. 27 shows that components constituting “Storage 1” are, for example, Volume 1, Volume 2, Volume 3, Power Unit 1, and Power Unit 2; and “Storage 1” is not normal and Power Unit 1 and Power Unit 2 have failed.

Accordingly, the status of components can be changed and displayed depending on the status of the administrator such as the job administrator or the device administrator. For example, the component display screen 510 in FIG. 25 which is displayed for the job administrator is displayed to show that the general status of Volume 1 of Storage 1 is not normal and such general status is caused by the base components. Furthermore, the component display screen 530 in FIG. 27 which is displayed for the device administrator is displayed to show that the status of Storage 1 is not normal, each volume itself is in a normal state, and the power supply units have failed.

(5) Advantageous Effects of this Embodiment

According to this embodiment, when a node (monitoring target device) or a component is added to a job management group or a device management group (monitoring target group) as input by the job administrator or the device administrator and a failure occurs at a base component of the component: and if the status of the component is to be displayed via the monitoring target group, information indicating that the component is in a critical state is displayed; and if the status of the component is to be displayed without intermediary of the monitoring target group, information indicating that the component is in a normal state and the node or the base component is in a critical state is displayed. As a result, it is possible to efficiently recognize influences on the management target at the time of the occurrence of a failure by specifying a device related to the management target of the administrator and elements constituting the device and providing the status information about the management target in consideration of the status of the above-mentioned related device and elements.

### REFERENCE SIGNS LIST

100 management computer
111 configuration information acquisition unit
112 performance information acquisition unit
113 resource group management unit
114 display unit
200 display computer
211 display result displaying program
300 communication network
400 server
500 storage apparatus

1. An information processing unit for monitoring a plurality of monitoring target devices, the information processing unit comprising:
a memory unit for storing configuration information and status information about each of the monitoring target devices;
a control unit for monitoring status information about the monitoring target device and a component including a function and part constituting the monitoring target device; and
a display unit for displaying status information about the component;
wherein the control unit defines one or more monitoring target groups including the monitoring target device or the component of the monitoring target device as input by a monitoring user; and
wherein when a first component is included in the monitoring target group, a failure occurs at a second component, and there is a specified relationship between the first component and the second component, and
if a status of the first component is to be displayed via the monitoring target group, the control unit displays that the first component is in a critical state; and
if the status of the first component is to be displayed without intermediary of the monitoring target group, the control unit displays that the first component is in a normal state and the first monitoring target device or the second component is in a critical state.

2. The information processing unit according to claim 1,
wherein when the first component is added to the monitoring target group as input by the monitoring user, the control unit:
searches for the second component, which will have an influence on provision of a function of the first component, in accordance with a specified rule; and
adds the second component as a base component of the first component to the monitoring target group.

3. The information processing unit according to claim 2,
wherein when a plurality of base components are added as the first component to the monitoring target group and a failure occurs at one of the plurality of base components,
the control unit displays the status of the first component and aggregates and displays the status of the plurality of base components.

4. The information processing unit according to claim 3,
wherein the display unit displays the first component defined as the monitoring target group as input by the monitoring user; and
wherein when the monitoring user selects the first component displayed on the display unit, the control unit displays the status of the second component added to the monitoring target group as the base component of the first component.

5. The information processing unit according to claim 2,
wherein the memory unit:
stores a type of the specified component and a type of the base component of that component, as a specified rule for adding the base component to the monitoring target group, in a rule definition table by associating them with each other; and
stores the component and any one of specified rules for adding the base component to the component in a component status management table by associating them with each other; and
wherein the control unit:
decides the specified rule corresponding to the component according to the component status management table and searches for the second component, which will have an influence on provision of the function of the first component, in accordance with the specified rule of the rule definition table; and
adds the second component as the base component of the first component to the monitoring target group.

6. The information processing unit according to claim 5,
wherein the memory unit stores the monitoring target device, a component of the monitoring target device, and a component related to the component of the monitoring target device in a component relation table by associating them with each other; and
wherein when the component is added to the monitoring target group as input by the monitoring user,
the control unit:
decides a specified rule corresponding to the type of the component by referring to the rule definition table;
acquires the component related the component by referring to the component relation table; and
decides whether or not to add the acquired component related to the component as the base component of the component to the monitoring target group in accordance with the specified rule.

7. The information processing unit according to claim 6,
wherein when the monitoring target device is added to the monitoring target group as input by the monitoring user, the control unit adds the component constituting the monitoring target device to the monitoring target group.

8. A program for having a computer function as an information processing unit for monitoring a plurality of monitoring target devices, the information processing unit including:
a memory unit for storing configuration information and status information about each of the monitoring target devices;
a control unit for monitoring status information about the monitoring target device and a component including a function and part constituting the monitoring target device; and
a display unit for displaying status information about the component;
wherein the control unit defines one or more monitoring target groups including the monitoring target device or the component of the monitoring target device as input by a monitoring user; and
wherein when a first component is included in the monitoring target group, a failure occurs at a second component, and there is a specified relationship between the first component and the second component, and
if a status of the first component is to be displayed via the monitoring target group, the control unit displays that the first component is in a critical state; and
if the status of the first component is to be displayed without intermediary of the monitoring target group, the control unit displays that the first component is in a normal state and the first monitoring target device or the second component is in a critical state.
